(19) United States
(12) Patent Application Publication
(10) Pub. No.: US 2023/0205549 A1
(43) Pub. Date: Jun. 29, 2023

(54) VIRTUAL CONTROLLER IN A MULTI-NODE SYSTEM

(71) Applicant: Quanta Computer Inc., Taoyuan City (TW)

(72) Inventor: Chin-Fu TSAI, Taoyuan City (TW)

(21) Appl. No.: 17/646,277

(22) Filed: Dec. 28, 2021

(51) Int. Cl. G06F 9/4401; G06F 9/455

(52) U.S. Cl. CPC G06F 9/4416; G06F 9/45558; G06F 2009/45595

(57) ABSTRACT

A remote virtual system for remote boot up of a BMC on a node of a networked multi-node system is disclosed. A host server stores a firmware image. A network is coupled to the host server. A first node is coupled to the network. The first node includes a first controller executing the firmware image. The host server boots-up the controller and sends the firmware image to the first controller to complete a boot-up of the controller.

### TECHNICAL FIELD

The present disclosure relates generally to a virtual baseboard management controller (BMC) for multi-node computer systems. More particularly, aspects of this disclosure relate to a multi-node network system that uses a host server to store a BMC firmware image for execution by BMCs on multiple networked nodes via remote boot-up.

### BACKGROUND

Servers are employed in large numbers for high demand applications, such as network-based systems or data centers. The emergence of cloud computing applications has increased the demand for data centers. Data centers have numerous servers that store data and run applications accessed by remotely-connected computer device users. A typical data center has physical rack structures with attendant power and communication connections. Each rack may hold multiple computing servers and storage servers. Each server generally includes hardware components such as processors, memory devices, network interface cards, power supplies, and other specialized hardware. Servers generally include a baseboard management controller (BMC) that manages the operation of hardware components as well as support components such as power supplies and fans. The BMC also communicates operational data to a central management station that manages the servers of the rack through a network. The BMC relieves the need for the Central Processing Unit (CPU) of the server to monitor server operations. Thus, a BMC must be capable of interfacing with numerous varieties of hardware components on a given server and collecting operational data from such hardware components.

A baseboard management controller may be a chip set with a complex processor such as, but not limited to, those sold by ASPEED Technology, Nuvotech, and TI. Currently known BMCs also include multiple input/output interface circuits to allow communication with a variety of hardware components using different communication protocols as well as network interface capabilities. Such BMCs require firmware to allow programming of the complex processor in the BMC to perform different functions.

During BMC boot up in known servers, a BMC firmware image stored in flash memory is loaded to random access memory (RAM) through the BMC chipset. As explained above, a BMC monitors all hardware in a computer system to allow discovery of parts that may have problems during computer system operation. However, the flash drive required for storing the BMC firmware image is an additional cost required in production of the server. Further BMC firmware is upgraded frequently. In this situation, it is required to update each BMC firmware image individually. This process becomes cumbersome when there are thousands of servers in a data center, as a technician must manually load the upgrade to each flash drive.

Thus, there is a need for a system that allows sharing a single BMC firmware image to all servers on a network. There is another need for a technique to ensure BMC firmware is correct for each of a number of servers in a cost effective manner that simplifies motherboard design and reduces human resources. There is also a need for a method for remote boot-up for BMCs on networked nodes.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a remote virtual system for remote boot-up is disclosed. A host server stores a firmware image. A network is coupled to the host server. A first node is coupled to the network. The first node includes a first controller executing the firmware image. The host server boots-up the controller and sends the firmware image to the first controller to complete a boot-up of the controller

A further implementation of the example system is an embodiment where the first controller is a baseboard management controller (BMC) and the firmware image is a BMC firmware image. Another implementation is where the first controller includes RAM to store the received firmware image. Another implementation is where the example system further includes a storage device coupled to the host server storing a boot-up routine allowing remote boot-up of the first controller. Another implementation is where the example system further includes a second node including a second controller executing the firmware image. The host server boots up the second controller and sends the firmware image to the second controller to complete the boot-up of the second controller. Another implementation is where the example system further includes a second node including a second controller executing a second type of firmware image. The host server stores the second type of firmware image. The host server boots up the second controller and sends the second type of firmware image to the second controller to complete the boot-up of the second controller. Another implementation is where the host server is configured to send a firmware upgrade image to the first controller. Another implementation is where the host server runs a Dynamic Host Configuration Protocol (DHCP) routine for network connection to the first controller, a pre-boot execution environment (PXE) routine for remote boot-up of the first controller, and a Trivial File Transfer Protocol (TFTP) routine for transferring the firmware image. Another implementation is where the first node has a second type of controller executing a second type of firmware image. The host server stores the second type of firmware image and boots up the second controller. The host server sends the firmware image to the second controller to complete a boot-up of the second controller.

Another disclosed example is a host server for providing a virtual controller to nodes in a multi-node system. The host server includes a storage device storing a first controller firmware image. The host server includes a network storage device storing a boot-up routine. The host server includes a network interface allowing communication via network to a plurality of nodes. Some of the nodes include a controller executing the first controller firmware image. The host server includes a processor that executes the boot routine to boot-up the controller of one of the plurality of nodes. The processor sends the first controller firmware image via the network to the controller of one of the plurality of nodes.

A further implementation of the example host server is an embodiment where the controller is a baseboard management controller (BMC) and the firmware image is a BMC firmware image. Another implementation is where the storage device stores a second controller firmware image that differs from the first controller firmware image. The processor boots up a controller of a second node of the plurality of nodes, and sends the second controller firmware image to the second node. Another implementation is where the processor is operable to send a firmware upgrade image to the node. Another implementation is where the node has a second type of controller executing a second controller firmware image. The storage device stores the second controller firmware image. The processor is operable to execute the boot routine to boot-up the second controller, and send the second controller firmware image via the network to the second controller.

Another disclosed example is a computer system that includes a baseboard management controller (BMC) including a random access memory (RAM) for storing a BMC firmware image for execution by the BMC, and a read only memory including code for remote boot-up. The computer system includes an external network interface allowing network communication to a remote host server to receive a BMC firmware image. The BMC is operable to be booted-up remotely and load the received BMC firmware image to the RAM.

A further implementation of the example computer system is an embodiment where the read only memory includes code for receiving a file via network communication. The host server runs a Dynamic Host Configuration Protocol (DHCP) routine for network connection to the computer system, a pre-boot execution environment (PXE) routine for remote boot-up of the BMC, and a Trivial File Transfer Protocol (TFTP) routine for transferring the BMC firmware image.

Another disclosed example is a method of remote booting of a controller on a node of a plurality of networked nodes. A firmware image executable by the controller is stored in a host server remote from the node. A boot-up of the controller from the host server is initiated via the network. The stored firmware image to the controller is sent via the network. The firmware image is loaded to random access memory. The firmware image is executed by the controller.

A further implementation of the example method is an embodiment where the controller is a baseboard management controller (BMC) and the firmware image is a BMC firmware image. Another implementation is where the example method further includes storing an upgraded firmware image executable by the controller in the host server. A boot-up of the controller is initiated from the host server via the network. The stored upgraded firmware image is sent to the controller via the network. The upgraded firmware image is loaded to random access memory and executed by the controller.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is block diagram of a computer system having a baseboard management controller (BMC) that accesses a remote BMC firmware image, according to certain aspects of the present disclosure;

FIG. 2 is a block diagram of a networked multi-node system that utilizes a virtual BMC for each of the nodes, according to certain aspects of the present disclosure; and

FIG. 3 is a flow diagram of the process of accessing a host based BMC firmware image performed by any of the nodes in FIG. 2, according to certain aspects of the present disclosure.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

The present disclosure relates to a networked multi-node system that includes a host server that serves as a virtual controller for each of the nodes. Each of the nodes may be networked devices such as servers. The nodes all have a hardware controller such as a baseboard management controller (BMC) to assist in monitoring server operation. The system allows for a virtual BMC pre-boot execution environment (PXE) boot from a networked device such as an SD card or an embedded multi-media card (eMMC). A BMC firmware image stored on the host server is shared with all of the nodes. Thus, when a BMC of any of the nodes is booted-up, it accesses the host server to copy the stored BMC firmware image. This eliminates the necessity of having a flash drive dedicated for storing BMC firmware image on the server. This arrangement functions as a virtual BMC on the host server to replace current flash memories on each node. The disclosed system allows cost reduction, simplified server schematic layouts, and increased performance. The disclosed system also reduces human resources necessary to maintain BMCs in multiple nodes.

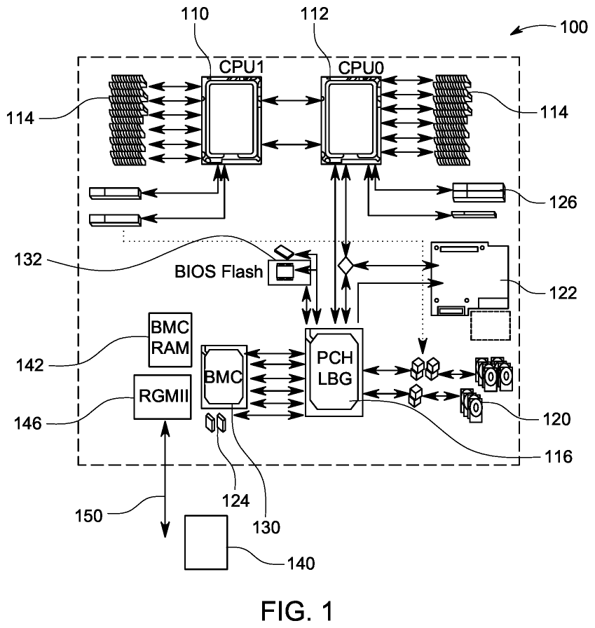

FIG. 1 is a block diagram of the components of a typical network node in a data center. In this example, the network node is a computer system 100. In this example, the computer system 100 is a server, but any suitable computer device can incorporate the principles disclosed herein. The computer system 100 has two central processing units (CPU) 110 and 112. The two CPUs 110 and 112 have access to dual in-line memory modules (DIMM)s 114. Although only two CPUs are shown, additional CPUs may be supported by the computer system 100. Specialized functions may be performed by specialized processors such as a GPU or a field programmable gate array (FPGA) mounted on a motherboard or on an expansion card in the computer system 100.

A platform controller hub (PCH) 116 facilitates communication between the CPUs 110 and 112 and other hardware components such as serial advanced technology attachment (SATA) devices 120, Open Compute Project (OCP) devices 122, and USB devices 124. The SATA devices 120 may include hard disk drives (HDD)s. Alternatively, other memory storage devices such as solid state drives (SSD)s may be used. Other hardware components such as PCIe devices 126 may be directly accessed by the CPUs 110 or 112 through expansion slots (not shown). The additional PCIe devices 126 may include network interface cards (NIC), redundant array of inexpensive disks (RAID) cards, field programmable gate array (FPGA) cards, and processor cards such as graphic processing unit (GPU) cards.

The hardware components of the computer system 100 must be functional when examined by a start-up routine in the basic input-output system (BIOS) for the computer system 100 to successfully boot-up. Thus, the BIOS initializes and trains memory devices and PCIe devices 126. The BIOS also allocates the resources required for the PCIe devices 126. Additional hardware components may also be functional for the BIOS to successfully boot-up the computer system 100. A separate basic input-output system (BIOS) flash memory device 132 is a non-volatile memory such as flash memory that stores the BIOS firmware. The flash memory device 132 may be accessed through the PCH 116 to facilitate loading of the BIOS firmware when the CPUs 110 and 112 are booted-up.

A baseboard management controller (BMC) 130 manages operations such as power management and thermal management for the computer system 100. As will be explained, the BMC 130 may load a BMC firmware image 140 that is stored externally through a host server. The BMC 130 has access to a block of a random access memory (RAM) 142 during operation of the BMC 130. The BMC 130 is capable of network communication through a network interface 146. In this example, the network interface 146 is a reduced gigabit media-independent interface (RGMII) type device. The BMC 130 accesses the BMC firmware image 140 through a network 150 when the BMC 130 is booted-up. In this example, the network 150 is a local area network (LAN) that allows remote supervision of nodes from a host server. The BMC 130 utilizes the network interface 146 to send and receive data through the network 150. The BMC firmware image 140 is loaded into the RAM 142 for execution by the BMC 130. The computer system 100, therefore, does not require a flash memory dedicated to the BMC 130. The network interface 146 allows certain BMC functions such as firmware image access to be performed remotely through a “virtual BMC” run by the host server 220.

Although the computer system 100 in FIG. 1 has a single motherboard that includes the BMC 130, other computer system architectures that use a BMC may adapt the principles described herein. For example, some server chassis arrangements may have multiple motherboards, each with separate processors and/or storage devices, all supported by a single BMC. In such an arrangement, the BMC monitors the hardware components on all of the motherboards.

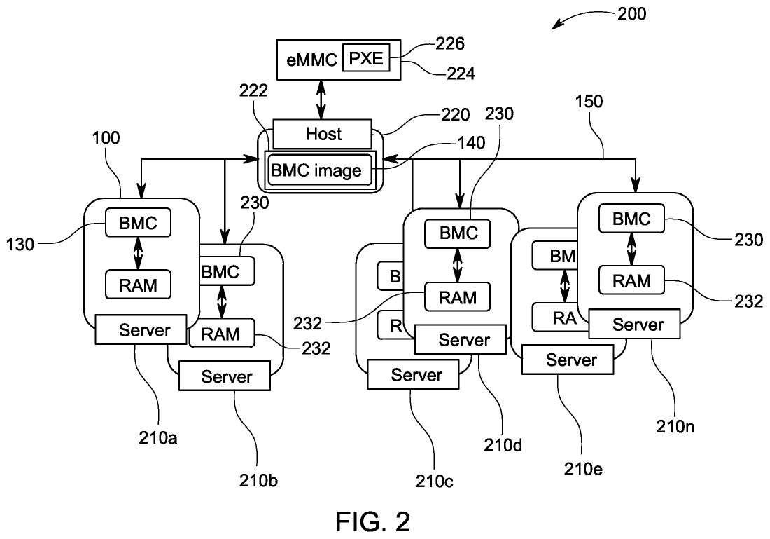

FIG. 2 shows a networked multi-node network system 200, such as a data center with multiple nodes 210a, 210b, 210c, 210d, 210e, and 210n. One of the nodes 210a is the computer system 100 in FIG. 1. As will be explained, the other nodes 210b, 210c, 210d, 210e, and 210n, may be servers that are identical to the computer system 100 to allow for more streamlined maintenance and monitoring by a data center operator. The nodes 210a, 210b, 210c, 210d, 210e, 210d, and 210n are coupled to the network 150, which allows communication with a host server 220. In this example, the host server 220 manages each of the nodes 210a, 210b, 210c, 210d, 210e, 210d, and 210n. The host server 220 may manage other nodes through the network 150 and thus is not limited to the nodes 210a, 210b, 210c, 210d, 210e, 210d, and 210n. As will be explained, the host server 220 includes a network interface that manages communication via the network 150. The processor or processors of the host server 220 executes a boot routine to boot-up a controller, such as a BMC, of any of the nodes 210a, 210b, 210c, 210d, 210e, 210d, and 210n. The processor or processors of the host server 220 are also operable to direct sending a firmware image stored by the host server 220 to any of the nodes 210a, 210b, 210c, 210d, 210e, 210d, and 210n via the network 150.

The host server 220 also has capabilities to run certain BMC functions and thus may be considered a virtual BMC for each of the nodes 210a, 210b, 210c, 210d, 210e, 210d, and 210n. In this example, each of the nodes 210b, 210c, 210d, 210e, and 210n have a BMC 230 that allows the BMC firmware image 140 to be loaded into a RAM 232 for execution. Each of the BMCs 230 has identical chipsets to the BMC 130 of the computer system 100 in FIG. 1. As explained above, each of the BMCs 230 executing the BMC firmware image 140 allows monitoring of the corresponding server hardware such as processors, storage devices, power devices, network interface controllers, and the like.

In this example, the host server 220 includes a permanent storage device 222 such as a SSD or HDD that stores the BMC firmware image 140. The BMC firmware image 140 may be sent via the network 150 to any of the BMCs 230 of the nodes 210a, 210b, 210c, 210d, 210e, and 210n when the BMC 230 is booted-up. The host server 220 has access to networked storage devices such as an eMMC 224 or an SD card that stores a pre-boot execution environment (PXE) boot routine 226. In this example, the boot-up occurs through a PXE interface run by the host server 220 for any of the BMCs 230 of the nodes 210a, 210b, 210c, 210d, 210e, and 210n. Alternatively, the boot-up may be initiated locally from any of the BMCs 230 of the nodes 210a, 210b, 210c, 210d, 210e, and 210n.

The boot-up of an individual BMC 230 is initiated from a built-in PXE interface accessing the PXE boot routine 226 to find a PXE server to boot-up. In this example, the BMCs 230 each includes code in read only memory (ROM) to support a PXE boot, a Netboot Boot Server Discovery Protocol (BSDP), and a loader for loading the BMC firmware image 140 from the network 150. The PXE boot routine 226 allows remote booting by interfacing with the PXE boot code in the ROM of the target BMC 230. The BMC 230 uses Dynamic Host Configuration Protocol (DHCP) to acquire the IP address of the host server 220 and thus acquire the boot image resources for boot-up of the BMC 230. The Netboot BSDP allows dynamic acquisition of resources to boot a suitable operating system for the target BMC 230.

Thus, any of the BMCs of the nodes 210a, 210b, 210c, 210d, 210e, and 210n may be booted up remotely by the host server 220. In addition, during the boot-up process, the target BMC 230 communicates with the host server 220 and downloads the BMC firmware image 140 via a file transfer protocol such as Trivial File Transfer Protocol (TFTP). Thus, the system supports a virtual BMC configuration as all of the nodes 210a, 210b, 210c, 210d, 210e, and 210n share the same BMC firmware image 140 via the network 150, and may be booted-up remotely from the host server 220.

Since any of the BMCs 230 can download the BMC firmware image 140 during boot-up, none of the nodes 210a, 210b, 210c, 210d, 210e, and 210n require a flash memory to store the BMC firmware image. Further, replacement images or upgrades of the firmware image 140 may be stored by the host server 220. Such replacement or upgrade firmware images may be distributed by the host server 220 each time one of the BMCs 230 is booted-up. This obviates the need to individually update firmware images for each node 210a, 210b, 210c, 210d, 210e, and 210n.

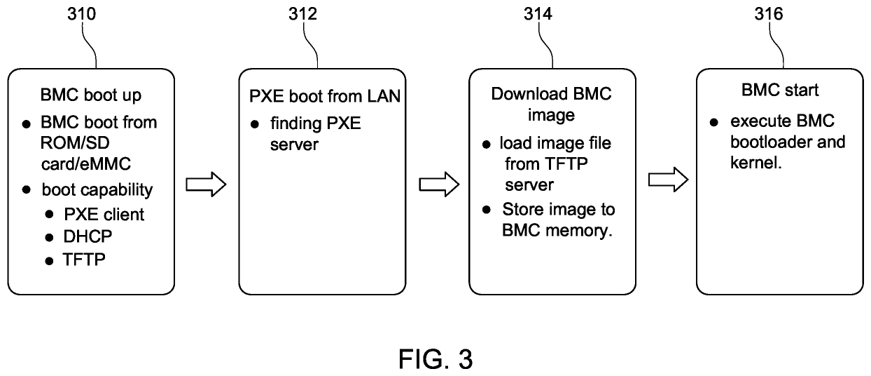

FIG. 3 shows a flow diagram of the process of remote boot-up and access to the BMC firmware image for the nodes 210a, 210b, 210c, 210d, 210e, and 210n in FIG. 1. In this example, the boot-up for any of the BMCs 230 is initiated by the host server 220 (310). The BMC boot 310 includes accessing the BMC boot code stored on the eMMC 224 in FIG. 2. Of course other storage devices may store the BMC boot code such as a SSD or another non-volatile memory device. The boot capability is enabled by executing the PXE client, DHCP, and TFTP stored on the ROM of the target BMC 230 through the network 150. The DHCP establishes a network connection between the host server 220 and the target BMC 230. The PXE client allows the remote boot-up of the BMC 230 through the PXE boot routine 226. The TFTP allows the transfer of files such as the firmware image 140 over the network 150.

The host server 220 then initiates the remote boot from the network 150 (312). The remote boot requires the BMC 230 finding the remote PXE server, which is the host server 220 in this example, via the DHCP. The host server 220 then initiates the transfer of the BMC firmware image 140 to the target BMC 230 (314). In this example, the host server 220 serves as a TFTP server and transfers the BMC firmware image 140 via TFTP over the network 150 to the target BMC 230. The received BMC firmware image 140 is stored in RAM 232 by the BMC 230. The BMC 230 may then be started (316). The BMC 230 may then execute the BMC boot loader and kernel to load and then execute the BMC firmware image 140 now stored in RAM 232.

The above principles may be used to distribute firmware images for other programmable devices on the nodes. For example, a complex programmable logic device (CPLD) may execute firmware to assist in power management on the computer system 100. Such a firmware image for programming the CPLD for power management functions may be centralized for all nodes by the host server 220. Another alternative may allow the host server 220 to save a BIOS image for each node thus eliminating the need for the flash memory device 132 in FIG. 1. In either case, the correct firmware image is loaded from the host server 220 to random access memory for execution by a programmable device such as the CPU 110 or a CPLD.

Alternatively, the host server 220 may store multiple firmware images for different types of BMCs. Thus, there may be one group of servers having a first architecture design and a second group of servers having a second architecture design, thus each requiring a different BMC firmware image. The host server 220 may be programmed to load the correct firmware image for the different architectures. Alternatively, additional host servers similar to the host server 220 may be used to support each type of architecture for remote loading of BMC firmware images.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A remote virtual system for remote boot up, comprising:
a host server storing a firmware image;
a network coupled to the host server; and
a first node coupled to the network, the first node including a first controller executing the firmware image, wherein the host server boots-up the first controller and sends the firmware image to the first controller to complete a boot-up of the first controller.

2. The system of claim 1, wherein the first controller is a baseboard management controller (BMC) and the firmware image is a BMC firmware image.

3. The system of claim 1, wherein the first controller includes RAM to store the received firmware image.

4. The system of claim 1, further comprising a storage device coupled to the host server storing a boot-up routine allowing remote boot-up of the first controller.

5. The system of claim 1, further comprising a second node including a second controller executing the firmware image, wherein the host server boots up the second controller and sends the firmware image to the second controller to complete the boot-up of the second controller.

6. The system of claim 1, further comprising a second node including a second controller executing a second type of firmware image, wherein the host server stores the second type of firmware image, and wherein the host server boots up the second controller and sends the second type of firmware image to the second controller to complete the boot-up of the second controller.

7. The system of claim 1, wherein the host server is configured to send a firmware upgrade image to the first controller.

8. The system of claim 1, wherein the host server runs a Dynamic Host Configuration Protocol (DHCP) routine for network connection to the first controller, a pre-boot execution environment (PXE) routine for remote boot-up of the first controller, and a Trivial File Transfer Protocol (TFTP) routine for transferring the firmware image.

9. The system of claim 1, wherein the first node has a second controller executing a second type of firmware image, wherein the host server stores the second type of firmware image, boots up the second controller, and sends the firmware image to the second controller to complete a boot-up of the second controller.

10. A host server for providing a virtual controller to nodes in a multi-node system, the host server comprising:
a storage device storing a first controller firmware image;
a network storage device storing a boot-up routine;
a network interface allowing communication via a network to a plurality of nodes, some of the plurality of nodes including a controller executing the first controller firmware image; and
a processor operable to:
execute the boot-up routine to boot-up the controller of one of the plurality of nodes; and
send the first controller firmware image via the network to the controller of one of the plurality of nodes.

11. The host server of claim 10, wherein the controller is a baseboard management controller (BMC) and the firmware image is a BMC firmware image.

12. The host server of claim 10, wherein the storage device stores a second controller firmware image that differs from the first controller firmware image, wherein the processor is operable to boot up a controller of a second node of the plurality of nodes, and send the second controller firmware image to the second node.

13. The host server of claim 10, wherein the processor is operable to send a firmware upgrade image to the one of the plurality of nodes.

14. The host server of claim 10, wherein the node has a second controller executing a second controller firmware image, wherein the storage device stores the second controller firmware image, and wherein the processor is operable to:
execute the boot-up routine to boot-up the second controller; and
send the second controller firmware image via the network to the second controller.

15. A computer system comprising:
a baseboard management controller (BMC) including a random access memory (RAM) for storing a BMC firmware image for execution by the BMC and a read only memory including code for remote boot-up; and
an external network interface allowing network communication to a remote host server to receive a BMC firmware image, wherein the BMC is operable to be booted-up remotely and load the received BMC firmware image to the RAM.

16. The computer system of claim 15, wherein the read only memory includes code for receiving a file via network communication, wherein the remote host server runs a Dynamic Host Configuration Protocol (DHCP) routine for network connection to the computer system, a pre-boot execution environment (PXE) routine for remote boot-up of the BMC, and a Trivial File Transfer Protocol (TFTP) routine for transferring the BMC firmware image.
